(19) United States
(12) Patent Application Publication
(10) Pub. No.: US 2004/0022905 A1
(43) Pub. Date: Feb. 5, 2004

(54) Frozen cake decorating kit

(75) Inventor: Loralei A. Verba, Holland Township, NJ (US)

Correspondence Address: Kenneth P. Glynn, Esq., Glynn & Associates, P.C., 24 Mine Street, Flemington, NJ, 08822, US

(73) Assignee: Cakes Unlimited, Inc.

(21) Appl. No.: 10/211,864

(22) Filed: Aug. 5, 2002

(51) Int. Cl. A23B 4/00

(52) U.S. Cl. 426/112

(57) ABSTRACT

The present invention involves a method of creating a decorated cake product, and a kit for creating the product. The method includes assembling a master package with contents that include at least one baked cake and at least one container of cake frosting; and, freezing the master package and its contents for storage and for subsequent use after storage. In some embodiments, there are a plurality of baked cakes included, e.g. two separate or three separate layers for making a layer cake. Each baked cake may be sealed in its own individual package, or they may be wrapped together in a single package. In either case, they are separate from the container or containers of cake frosting. The baked cakes are baked prior to assemblage and prior to being frozen to provide a product which need only be thawed and frosted, or frosted and thawed, to be served. The baked cakes may be partially frosted, but are generally completely unfrosted. At a minimum, there is one container of cake icing in the kit. In many embodiments, there are at least two containers of cake frosting, one as a base, and at least one for actual creation of decoration on the cake. Additional, optional items may be included, such as decorations, candles, dispensers, dispenser tips, decorating tools and instructions.

### BACKGROUND OF THE INVENTION

1. Field of the Invention

The present invention relates to a methodology for creating a decorated cake product, more specifically, the present invention relates to methods and kit products for preparing decorated cake products in a specific manner. Namely, in order to avoid or eliminate an end user's need to bake a cake in order to do unique decorations thereof the present invention involves assemblage of a master package which includes at least one baked cake and at least one separately packaged icing product, freezing same from, for example, a bakery, and maintaining the master package or kit in its frozen state until an end user desires to thaw it for custom decorating and subsequent consumption.

2. Information Disclosure Statement

The following patents are representative of enhancements in the cake decorating industry:

U.S. Pat. No. 5,758,802 describes an icing implement including a collapsible bulb-shaped container with an enlarged discharge mouth. A discharge nozzle and an adapter collar interposed between the enlarged container mouth and the relatively restricted internal passage of the nozzle to effectively seal to both and provide for movement of material from the container to the nozzle upon an axial compression of the bottom of the container. The collapse of the container is effected in equal volume increments with the container retaining its collapsed position.

U.S. Pat. No. 5,795,395 describes an apparatus and method for decorating a cake. A print head is provided that moves in a planar or linear domain and that dispenses edible colorant at positions corresponding to the pixels of a digital image. The cake is positioned parallel to the domain and displaced vertically from the domain by an appropriate displacement. The proper positioning of the cake is facilitated by a sensing mechanism for sensing the attitude of the cake with respect to the domain and a leveling mechanism, responsive to the sensing mechanism, for adjusting the attitude. A preferred sensing mechanism includes laser sources aimed at photodiode detectors; when the cake is properly positioned, the beams of light from the lasers are partially blocked. A preferred leveling mechanism includes adjustable legs supporting the table whereon the cake is placed under the print head.

U.S. Pat. Nos. 5,871,245 and 6,010,170 describe a finger-mounted, cake decorating device, which can receive and place a decoration, has a finger receiver with a protruding platform extending therefrom. A decoration is formed on either a rose nail or a rod. The platform receives the decoration as formed and permits a transfer of the decoration to a desired position.

U.S. Pat. No. 6,210,731 relates to a method of making edible decorations which reproduce all types of patterns, including color patterns. The purpose of these decorations is partially or totally to cover the cakes for which they are intended and for which they form a perfectly homogenous whole. More precisely, the invention consists in producing a printed decoration with five successive layers: a first layer of printed edible paper, and a second layer of a material for modifying the texture of the edible paper and sticking the first and third layers together. The third layer consists of a material belonging to the group comprising almond paste and chocolate. The fourth layer is equivalent to the second layer, and the fifth layer is equivalent to the first layer. By virtue of this innovation, a printed decoration does not detract from the cake and remains supple and homogenous.

Notwithstanding the prior art, the present invention is neither taught nor rendered obvious thereby.

### SUMMARY OF THE INVENTION

The present invention involves a method of creating a decorated cake product, and a kit for creating the product. The method includes assembling a master package for freezing, with contents which include at least one baked cake and at least one container of cake frosting; and, freezing the master package and its contents for storage and for subsequent use after storage. In some cases, one or more components of the kit may be frozen prior to assemblage. In other cases, all of the components are unfrozen prior to assemblage.

In some embodiments, there is at least one baked cake, while in many embodiments, a plurality of baked cakes is included, e.g. two separate or three separate layers for making a layer cake. The baked cake may be sealed in their own individual packages, or wrapped together, but are separate from the at least one container or containers of cake frosting. The baked cakes are baked prior to assemblage and prior to being frozen to provide a product which need only be thawed and frosted to be served. Alternatively, the icing step may be completed before the cake is thawed. This method is preferred by many professionals. The baked cakes may be partially frosted, but are generally completely unfrosted. At a minimum, there is one container of cake icing in the kit. In many embodiments, there are at least two containers of cake frosting, one as a base, and at least one for actual creation of decoration(s) on the cake.

In some preferred embodiments, the master package further includes an at least one frosting decorating dispenser, and may include a plurality of frosting decorating dispensers. It is preferable to include a plurality of frosting decorating dispenser tips, e.g. circles, stars, roses, borders, stripes, etc., which preferably are interchangeable.

The master package may also include supplemental decorative items selected from the group consisting of edible decorating items, plastic decorating items, metal decorating items, and combinations thereof. Further, fillings may also be included. These could be puddings, jams, jellies, yogurts, icings, nuts, raisins, jelly beans, etc.

The master package may be delivered to commercial or private facilities and may be kept frozen for future use or thawed for immediate use. The end user thaws the master package and the contents, and applies the frosting to the cake to create the finished frosted cake. Alternatively, the cake itself is kept frozen for the icing/decorating steps and then thawed.

By “cake”, as used herein, is meant any baked cake product which is completely or partially unfinished, i.e. is not fully decorated and/or iced. This cake may have any size and shape and be of regular or irregular shape, but is typically square, rectangular, round, or semi-torroidal. The present invention kit further includes at least one icing, and in many embodiments more than one icing is included. (The words “icing” and “frosting” are used interchangeably herein, even though in the food industry, they are recognized as different products. Fondants are also meant to be included in the use of “icing” and “frosting” as used herein.)

Typically, there may be one primary icing, such as buttercream, royal, flavored, such as white frosting or chocolate frosting or any other base, e.g. lemon-yellow frosting, and at least one secondary frosting for decorating such as the same or similar icings, or decorating gels, including with varying colors. Thus, it could have the same or different consistency and composition as the base.

In some preferred embodiments, at least one dispenser is included. This could be any type of conventional dispenser, including squeeze bags and piston-based ejection devices. Interchangeable decorative tips may also be included as well as supplemental decorative items. These decorative items could be edible items, inedible items or combinations thereof, such as metal, plastic or food-based forms and characters, flowers, beads, flakes, etc. In another preferred embodiment, edible photographic images of loved ones or honorees may be added. In other preferred embodiments, aluminum foil covered icons, lettering, etc. may be included.

Tools may optionally be included in the present invention kits, such as spatulas, cake combs, cake stands, etc.

While the primary purpose of the present invention kit and methodology is to give the end user the opportunity to decorate cakes without having to go through the messy steps of baking them, another purpose is to offer speed and convenience in the preparation and customized presentation of the specialty cakes and special occasion cakes. These include but are not limited to wedding cakes, anniversary cakes, confirmation cakes, graduation cakes, shower cakes, birthday cakes, get well, Easter cakes, Halloween cakes, Christmas cakes, Hanukkah cakes, doll cakes, character cakes and other specialty cakes.

### BRIEF DESCRIPTION OF THE DRAWINGS

The present invention should be more fully understood when the specification herein is taken in conjunction with the drawings appended hereto wherein:

FIG. 1 shows a schematic diagram of a present invention methodology,

FIG. 2 shows a top view of a present invention kit;

FIG. 3 shows a side view of a plurality of baked cakes, stacked and separated and packaged and sealed together; and,

FIG. 4 shows a top view of an alternative embodiment present invention kit containing a plurality of cupcakes and tubes of icing.

### DETAILED DESCRIPTION OF THE PRESENT INVENTION

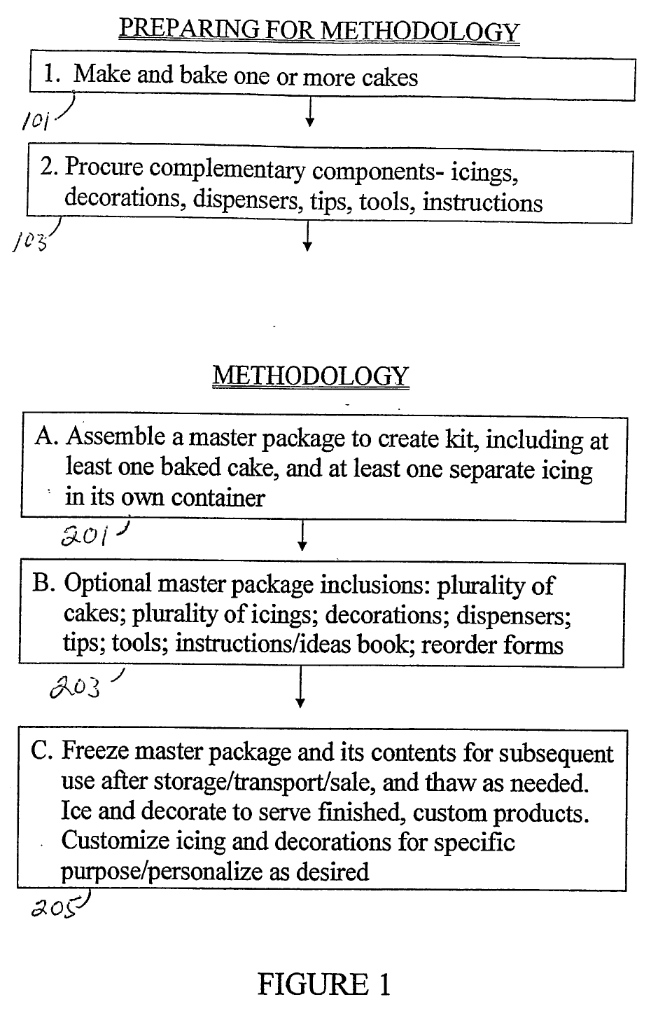

FIG. 1 shows the pre-methodology and the methodology of the present invention. Step 101 involves making and baking one or more cakes. Step 103 involves procuring complementary items, including the mandatory at least one icing, as well as the other optional items, as desired.

In FIG. 1, the methodology involves step 201, the assemblage of a master package. (The master package and its contents constitute a present invention kit when frozen.) In step 203, the optional, desired items are included in the master package. In step 205, the master package and its contents are frozen. In the frozen state, the kit may be stored, transported, sold or otherwise retained or distributed. When ready for use, it is thawed, the cakes are removed, frosted, decorated and served.

FIG. 2 shows a top view of one embodiment of a present invention kit 1. This includes the master package 3, which consists of a box sealed with a clear plastic top. Alternatively, the box may be unsealed, and may or may not have a window. Master package 3 contains a cardboard insert 5, one or more cakes 7, wrapped in its own plastic seal 9, and other complementary items. These include various frosting containers 11, 13, 15 and 17, which might contain chocolate, white, red and green icings. There is also a stack of icing dispensers 19 and interchangeable tips 21, 23, 25, and 27 for attachment to the dispensers, there is an instruction booklet and a plastic disposable combination spatula/stylus 31.

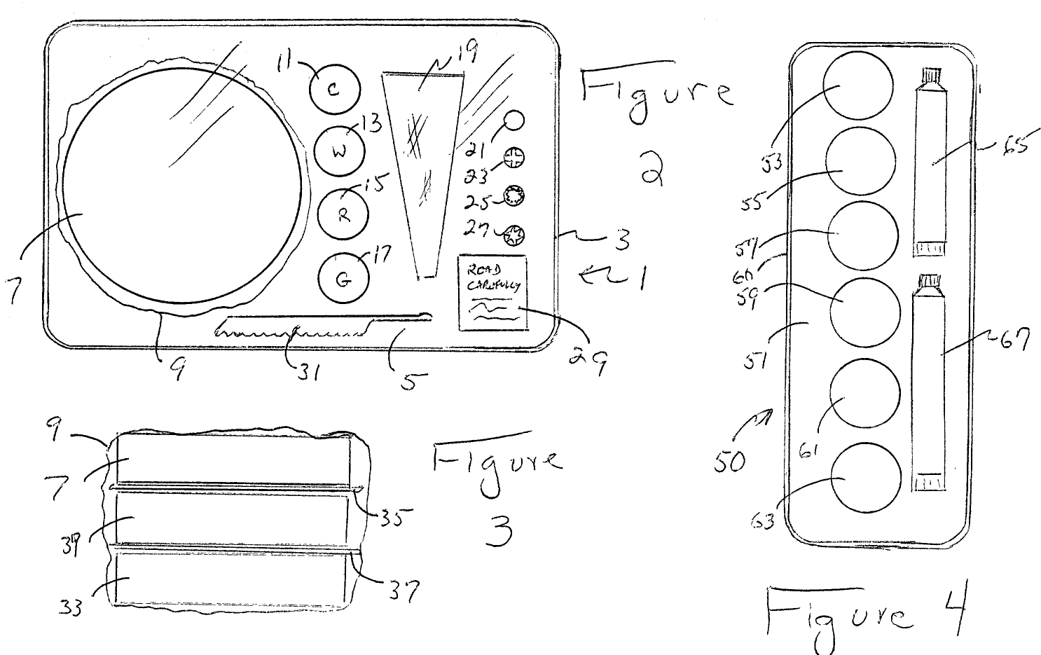

FIG. 3 shows a side view of cake 7 of FIG. 2 with additional cake layers 33 and 39, with anti-stick paper 35 and 37 therebetween. Although these layers could be individually wrapped, here they are stacked with separator papers and sealed together with plastic seal 9.

FIG. 4 shows a top view of an alternative embodiment present invention kit 50, which involves a master package 60 and a half dozen baked, unfrosted cupcakes 53, 55, 57, 59, 61, and 63. They are kept in place and supported by a plastic insert 51. Also included are two tubes of frosting 65 and 67. These would be of different colors and/or flavors and could be directly dispensed from the tubes to the cupcakes. For example, the user could make alternating chocolate and white swirls or concentric circles or alternating with half having a white background and half having a black background with the opposite color for messages, polka dots or stripes.

Obviously, numerous modifications and variations of the present invention are possible in light of the above teachings. It is therefore understood that within the scope of the appended claims, the invention may be practiced otherwise than as specifically described herein.

What is claimed is:

1. A method of providing a decorating cake product, which comprises:
(a.) assembling a master package for freezing, with contents which include at least one baked cake and at least one container of cake frosting;
(b.) freezing said master package and its contents for storage and for subsequent use after storage.

2. The method of claim 1 wherein said at least one baked cake is completely unfrosted.

3. The method of claim 1 wherein said at least one baked cake is sealed in its own package separate from said at least one container of cake frosting.

4. The method of claim 1 wherein there are at least two baked cakes.

5. The method of claim 1 wherein there are a plurality of containers of different cake frostings.

6. The method of claim 1 wherein there are at least two containers of cake frosting and at least one frosting decorating dispenser.

7. The method of claim 1 wherein said master package further includes a plurality of frosting decorating dispensers.

8. The method of claim 6 wherein said master package further includes a plurality of frosting decorating dispenser tips.

9. The method of claim 7 wherein said master package further includes a plurality of frosting decorating dispenser tips.

10. The method of claim 1 wherein said master package further includes supplemental decorative items selected from the group consisting of edible decorating items, plastic decorating items, metal decorating items, and combinations thereof.

11. The method of claim 4 wherein said at least two baked cakes are each individually packaged.

12. The method of claim 1 wherein said method further includes at least:
(c.) thawing said master package and said contents;
(d.) applying said frosting to cake to create a frosted cake.

13. A frozen cake decorating kit for providing a decorated cake product, which comprises:
(a) a master package;
(b) at least one packaged, baked cake contained within said master package; and,
(c) at least one container of cake frosting;
wherein said entire kit is frozen.

14. The kit of claim 13 wherein said at least one baked cake is completely unfrosted.

15. The kit of claim 13 wherein there are a plurality of separately packaged baked cakes.

16. The kit if claim 13 wherein there are a plurality of containers of different cake frostings.

17. The kit of claim 13 which further includes:
(d) at least one frosting decorating dispenser.

18. The kit of claim 17 which further includes:
(e) a plurality of frosting decorating dispenser tips.

19. The kit of claim 17 wherein there are a plurality of frosting decorating dispensers.

20. The kit of claim 13 which further includes at least one supplemental item selected from the group consisting of tools, instructions, edible decorative items, plastic decorative items, metal decorative items, and combinations thereof.
